(19) United States
(12) Patent Application Publication
(10) Pub. No.: US 2020/0094152 A1
(43) Pub. Date: Mar. 26, 2020

(54) Apparatus and method for lighted swing seat

(71) Applicants: James L. Renner, JR., Suwanee, GA (US); Robert J. Lochner, Alpharetta, GA (US); Jeffrey James Newkirk, Lake Worth, FL (US)

(72) Inventors: James L. Renner, JR., Suwanee, GA (US); Robert J. Lochner, Alpharetta, GA (US); Jeffrey James Newkirk, Lake Worth, FL (US)

(21) Appl. No.: 16/583,227

(22) Filed: Sep. 25, 2019

Related U.S. Application Data
(60) Provisional application No. 62/736,556, filed on Sep. 26, 2018.

(51) Int. Cl. A63G 9/00; F21V 33/00

(52) U.S. Cl. CPC A63G 9/00; F21Y 2113/13; F21V 33/008

(57) ABSTRACT

A lighted swing seat has multiple colors of battery-powered or motion-activated LED lights in a housing with a translucent top surface. A controller is configured to flash the plurality of multicolor LEDs, in a set sequence or randomly. A motion sensor is configured to turn off the lights when the swing seat has not moved for a time period exceeding a delay time.

### RELATED APPLICATIONS

This non-provisional US Patent Application claims priority from U.S. Provisional Patent Application No. 62/736,556 file by applicants on Sep. 26, 2018.

### BACKGROUND

### Field of Invention

The current invention relates to an apparatus and method for a lighted swing seat. More particularly, a plurality of flashing colored LED lights are used to provide a safer and more enjoyable swing experience.

### SUMMARY OF INVENTION

In one embodiment of the current invention, multiple colors of battery-powered or motion-activated LED lights are provided in a swing seat having a translucent top surface. Each light or a set of lights of a color may be flashed in a fast cycle, a slow cycle, or randomly.

### DESCRIPTION OF FIGURES

FIG. 1 is a top perspective view of a first embodiment lighted swing seat.

FIG. 2 is a bottom perspective view of the lighted swing seat of FIG. 1.

FIG. 3 is a cross section view A-A of the lighted swing seat of FIG. 1.

FIG. 4 is a cross section view B-B of the lighted swing seat of FIG. 1.

FIG. 5 is a top view of the lighted swing seat of FIG. 1.

FIG. 6 is a front view of the lighted swing seat of FIG. 1.

FIG. 7 is a side view of the lighted swing seat of FIG. 1.

### DETAILED DESCRIPTION OF EMBODIMENT

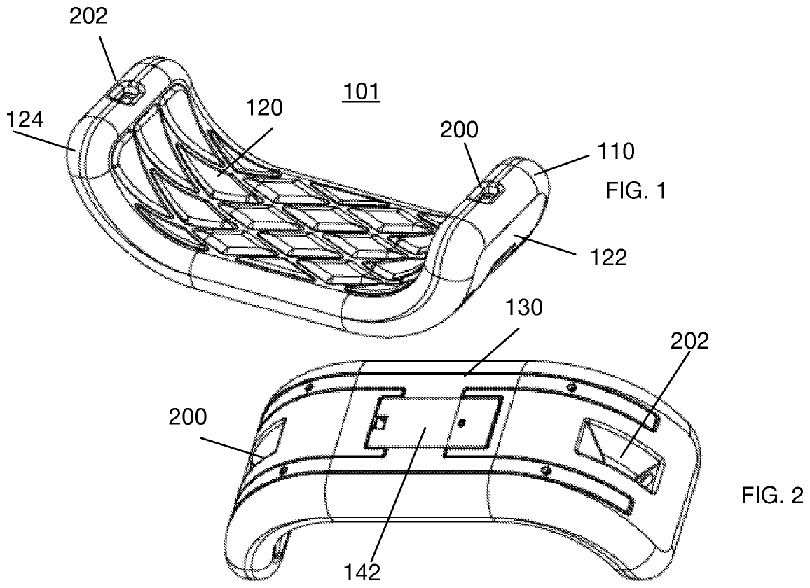

FIGS. 1-7 show a first embodiment of a lighted seat.

### ELEMENT LIST

The following list of elements is provided for convenience on review FIGS. 1-7.

lighted LED seat 101

seat housing 110
a translucent top surface 120
translucent side walls 122, 124
triangular lens features 126
4-sided parallelogram lens features 128
a bottom surface 130
a first cavity 140
   battery compartment door 142
a plurality of multicolor LEDs 150
   LED PCBs 152, 154, 156
battery 160;
a controller 170
manual on/off switch 180
motion sensor 190
swing attachment features 200, 202

FIG. 1 is a top perspective view of a first embodiment lighted swing seat 101 comprises a housing 110 with a translucent top surface 120, translucent side walls 122 and 124, and a bottom surface 130. In this example, the housing includes an upwardly-facing seat surface with concave translucent side walls.

FIG. 2 is a bottom perspective view of the lighted swing seat of FIG. 1 showing the bottom surface 130 and swing attachment features 200 and 202 to attach the seat to a swing frame or tree. In this case, the swing attachment features are holes to accept a rope. A battery compartment is accessed thorough compartment door 142.

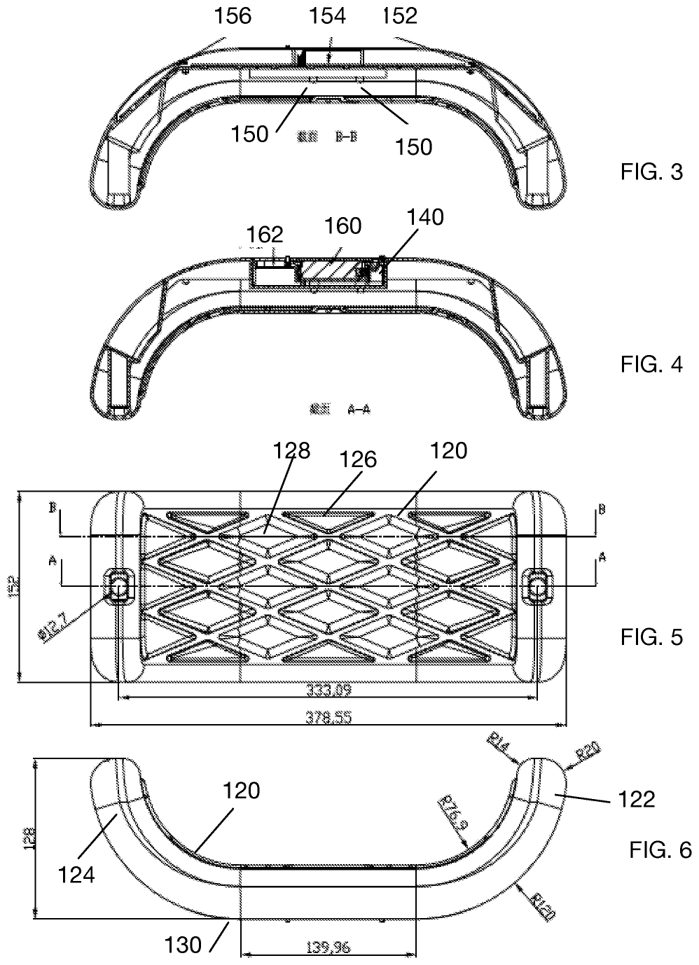

FIG. 3 is a cross section view A-A of the lighted swing seat of FIG. 1 showing LED PCBs 152, 154, and 156, each supporting a plurality of of multicolor LEDs 150. In this example a total of 24 LED light are provided in seven different colors.

FIG. 4 is a cross section view B-B of the lighted swing seat of FIG. 1 showing battery compartment 140, battery 160, and control PCB 170. In this example, three AA batteries are provided. In this embodiment, the controller includes a manual on/off switch and a motion sensor to save battery life.

FIG. 5 is a top view of the lighted swing seat of FIG. 1. In this embodiment, the top surface 120 comprises a plurality of triangular features 126 and 4-sided parallelogram features 128 to accent corresponding LEDs.

FIG. 6 is a front view of the lighted swing seat of FIG. 1.

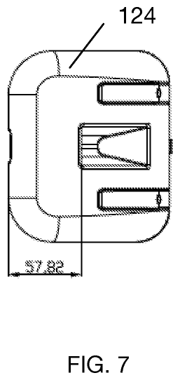

FIG. 7 is a side view of the lighted swing seat of FIG. 1 showing a first side 124.

Light Control

In one example, the LED lights are provided in seven different colors which flash randomly in a fast flashing cycle of about 12 seconds, in a fast cycle of about 6 seconds, with each color flashing about 0.42 seconds; and in a slow cycle of about 6 seconds, with each color flashing about 0.85 seconds.

In other examples, lights may flash in different patterns, or randomly.

In some examples, the seat may include a second ON/OFF switch as a “TRY ME” function on a side panel, so that prospective customers can observe the lights. This feature may be powered by a button battery.

While an exemplary embodiment of the device has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1. A lighted swing seat comprising
a seat housing comprising
a translucent top surface,
a bottom surface,
a first cavity provided between the top surface and the bottom surface
a plurality of multicolor LEDs;
at least one battery; and
a controller configured to flash the LEDs by directing current from the battery to each of the plurality of LEDs.

2. The lighted swing seat of claim 1 wherein
the controller is configured to flash the plurality of multicolor LEDs, in a set sequence or randomly, by directing current from the battery to each of the plurality of multicolor LEDs in flashing cycle.

3. The lighted swing seat of claim 2 wherein
the flashing cycle comprises a fast flashing cycle time and a slow flashing cycle time.

4. The lighted swing seat of claim 3 wherein
the flashing cycle is approximately 12 seconds, and comprises a fast flashing cycle time of approximately 6 seconds and a slow flashing cycle time of approximately 6 seconds.

5. The lighted swing seat of claim 1 wherein the
the plurality of multicolor LEDs further comprises LEDs of seven colors;
the fast flashing cycle comprises
a first flashing each of the LED colors for approximately 0.42 seconds, and a
second flashing of each of the LED colors for approximately 0.42 seconds; and
the slow flashing cycle comprises
a flashing each of the LED colors for approximately 0.85 seconds.

6. The lighted swing seat of claim 1 further comprising
a manual on/off switch.

7. The lighted swing seat of claim 1 further comprising
a motion sensor configured to turn off the lights when the swing seat has not moved for a time period exceeding a delay time.

8. The lighted swing seat of claim 1 further comprising
a motion sensor on/off switch configured to activate or deactivate the motion sensor.

9. The lighted swing seat of claim 1 wherein
the housing further comprises translucent concave side walls.

10. A lighted swing seat comprising
a seat housing comprising
a translucent top surface with translucent concave side walls, the top surface
configured to serve as a seat,
a bottom surface,
a first cavity provided between the top surface and the bottom surface
a plurality of multicolor LEDs;
at least one battery;
a controller configured to flash plurality of multicolor LEDs, in a set sequence or randomly, by directing current from the battery to each of the plurality of multicolor LEDs in flashing cycle; and
a motion sensor configured to turn off the lights when the swing seat has not moved for a time period exceeding a delay time.

11. The lighted swing seat of claim 10 wherein
the flashing cycle comprises a fast flashing cycle time and a slow flashing cycle time.

12. The lighted swing seat of claim 11 wherein
the flashing cycle is approximately 12 seconds, and comprises a fast flashing cycle time of approximately 6 seconds and a slow flashing cycle time of approximately 6 seconds.

13. The lighted swing seat of claim 10 wherein the
the plurality of multicolor LEDs further comprises LEDs of seven colors;
the fast flashing cycle comprises
a first flashing each of the LED colors for approximately 0.42 seconds, and a
second flashing of each of the LED colors for approximately 0.42 seconds; and
the slow flashing cycle comprises
a flashing each of the LED colors for approximately 0.85 seconds.

14. The lighted swing seat of claim 10 further comprising
a manual on/off switch.

15. The lighted swing seat of claim 10 further comprising
a motion sensor on/off switch configured to activate or deactivate the motion sensor.
